(19) United States
(12) Patent Application Publication
(10) Pub. No.: US 2007/0204398 A1
(43) Pub. Date: Sep. 6, 2007

(54) Portable eye wash system with disposable eye cups

(76) Inventor: Mark Dubois, Boynton Beach, FL (US)

Correspondence Address: John Christopher;Christopher & Weisberg, P.A., Suite 2040, 200 East Las Olas Boulevard, Fort Lauderdale, FL, 33301, US

(21) Appl. No.: 11/367,942

(22) Filed: Mar. 3, 2006

(51) Int. Cl. A61H 33/00; A61H 33/04

(52) U.S. Cl. 4/620

(57) ABSTRACT

The present invention provides a portable eyewash system having a main conduit able to receive fluid from various fluid sources. The main conduit is coupled to a fluid division conduit, which defines a fluid inlet, a first fluid outlet, and a second fluid outlet. The first and second fluid outlets are in fluid communication with first and second flexible tubes, respectively, which then direct fluid flow to first and second eyewash cups. The present invention may further include a fluid regulating element coupled to either flexible tube, as well as a pressure relief element in fluid communication with the main conduit.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to an apparatus for washing harmful substances from the eyes, and more particularly, to a portable eye wash system.

### BACKGROUND OF THE INVENTION

Emergency eyewash stations are commonly found in laboratories, warehouses, factories, and other places where corrosive or otherwise injurious materials may be present. Such stations provide immediate assistance typically by directing a stream of water towards the eyes in order to reduce the severity of an injury should some foreign substance get into the eyes of an individual. However, while existing eyewash stations may provide adequate means to flush the eyes with water, such eyewash stations are generally permanently installed and plumbed in a fixed location. As a result, in order to utilize the eye wash stations, the person affected must locate and proceed towards the eyewash station for aid. This can result in an unnecessary delay in administering aid, thereby increasing the chance of permanent or escalated severity of injury. In addition, such fixed eyewash stations require an installed fluid source, making them relatively useless in remote locations where no fixed plumbing is available, such as outdoors, in agricultural fields, etc.

Furthermore, typical eyewash stations provide a pair of nozzles that dispense two streams of water which converge with one another, requiring a person to position their face in the fluid stream in order to wash the eyes. The nozzles may or may not be adjustable or positionable to increase the exposure of the affected eye area to the fluid stream, and in either case, the fluid stream may not fully contact and adequately flush the harmful substance from the eyes. Moreover, if the stream does not fully contact the eye, a significant amount of fluid may be wasted, which can be especially vital if the fluid source is limited.

In light of the above drawbacks, it would be desirable to provide a portable eye wash system which is easily transported from place to place and could further receive fluid from virtually any fluid source. It would further be desirable to provide a portable eye wash system which effectively delivers a maximum amount of fluid to the affected eye region with minimum need for adjustment or positioning of the device.

### SUMMARY OF THE INVENTION

The present invention advantageously provides a portable eyewash system for use with a fluid source. The portable eyewash system includes a main conduit that defines an opening and an interior cavity, where the main conduit is engageable with the fluid source. The portable eyewash system can further include a fluid division conduit in fluid communication with the main conduit, with the fluid division conduit defining a fluid inlet, a first fluid outlet and a second fluid outlet. The portable eyewash system may further provide a first flexible tube coupled to the first fluid outlet, as well as a second flexible tube coupled to the second fluid outlet.

The present invention can also include a first eyewash cup in fluid communication with the first flexible tube, and a second eyewash cup in fluid communication with the second flexible tube. Each of the eyewash cups can be shaped to seal against the facial contours of an individual, and each may further include drainage apertures to allow fluid to exit the eyewash system when in use. In addition, a fluid regulation element can be coupled to either of the flexible tubes in order to manipulate the fluid flow therethrough. A pressure relief element may also be included in fluid communication with the main conduit to further safeguard and control the flow of fluid through the portable eyewash system.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates a perspective view of an embodiment of a portable eyewash system in accordance with the present invention; and

FIG. 2 shows an alternate view of the portable eyewash system of FIG. 1.

### DETAILED DESCRIPTION OF THE INVENTION

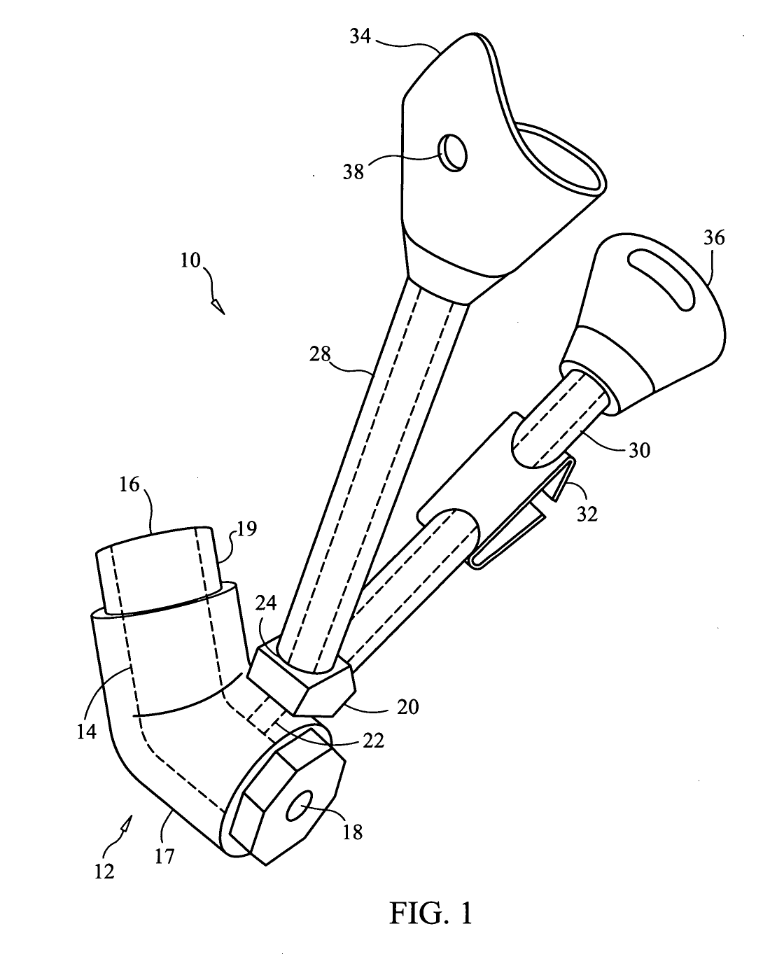

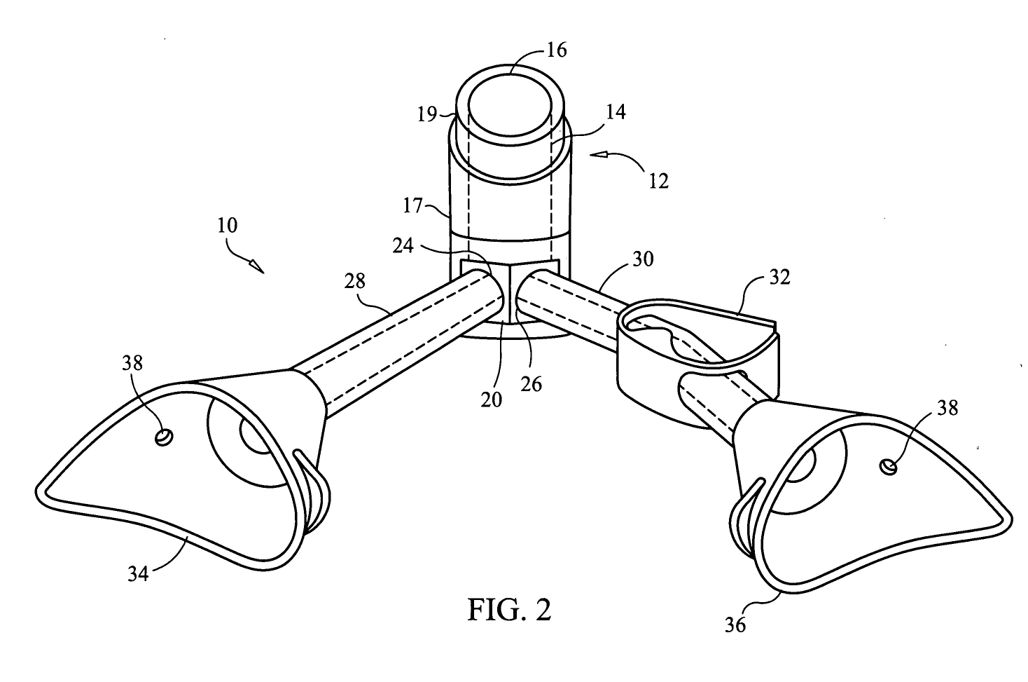

Now referring to FIGS. 1 and 2, in accordance with an exemplary embodiment, the present invention provides a portable eyewash system 10 including a main conduit 12 which is engageable with a common sink faucet or other fluid dispensing structure. The main conduit 12 defines a generally hollow interior cavity 14 and a first opening 16, whereby the first opening 16 provides access to the interior cavity 14. The interior cavity 14 can form a substantially obtuse angle at which fluid will flow through the interior cavity. In addition, the main conduit 12 can include a first portion 17 which is substantially rigid, as well as a second portion 19 which is substantially pliable. The substantially pliable second portion 19 can be frictionally engageable with a fluid source, thereby easing the coupling and subsequent removal of the portable eyewash system 10 with a fluid source. Moreover, the first opening 16 can further include a threaded portion or other affixation means (not shown) to facilitate attachment of the main conduit 12, and thus the portable eyewash system 10, to a faucet or fluid outlet. In addition, the main conduit 12 can include a pressure release valve 18 in fluid communication with the interior cavity 14.

The present invention further includes a fluid division conduit 20 coupled to and in fluid communication with the main conduit 12 of the portable eyewash system 10. The fluid division conduit 20 provides a generally hollow body that defines a fluid inlet 22, as well as a first fluid outlet 24 and a second fluid outlet 26, each of which is in fluid communication with the fluid inlet 22. As such, the fluid division conduit 20 diverts a single fluid path into two separate fluid paths, as typically achieved through a Y-splitter. Moreover, the first and second fluid outlets may each define flared end tips to assist in coupling and retaining flexible tubing, as further described below.

The portable eyewash system 10 further includes a first flexible tube 28 and a second flexible tube 30 in fluid communication with the first and second fluid outlets, respectively, of the fluid division conduit 20. The first and second flexible tubes 28, 30 may extend from the fluid division conduit 20 such that the flexible tubes are substantially perpendicular to a portion of the main conduit 12. This particular orientation can ease access to and the positioning of the portable eyewash system 10 and thus simplify the subsequent delivery of fluid to the affected areas of the eyes.

In addition, the first and second flexible tubes 28, 30 are sufficiently pliable as to be movably positioned to a desired location while remaining coupled to the fluid division conduit 20, while retaining enough structural rigidity as to resist kinking and obstruction of fluid flow through the tubing. As such, where the tubes preferably have a length substantially between approximately one inch and approximately ten inches, the first and second flexible tubes 28, 30 maintain a substantially longitudinal configuration independent of and without a need for additional support or supplementary structures to keep the flexible tubes in an upright position. Examples of suitable material for the tubing include latex, rubber, nylon, plastic, and composites thereof. The first and second flexible tubes 28, 30 can be placed over the flared end of the first and second fluid outlets, respectively, thereby providing a friction fit and preventing the unintended disengaging of the flexible tubing from the portable eyewash system 10. Moreover, replacement tubing and other features can be fitted and removed as needed through the coupling with the fluid outlets of the fluid division conduit 20.

In addition, a fluid regulation element 32 may be coupled to one or more of the first and second flexible tubes 28, 30, whereby the fluid regulation element 32 can be manipulated to either increase or decrease the potential for fluid flow through either of the flexible tubes. Examples of possible fluid regulation elements include clamps, valves, and other fluid regulating mechanisms as are known in the art. One such embodiment of the fluid regulation element 32 can include a pinch clamp which applies pressure to the exterior diameter of either of the flexible tubes, thereby decreasing the inner diameter of the tube and thus restricting the flow rate of fluid through the tube.

The present invention also provides a first eyewash cup 34 and a second eyewash cup 36, where both the first and second eyewash cups are in fluid communication with the first and second flexible tubes, respectively. The pair of eyewash cups can be shaped to conform to the facial contours around the eyes of an individual to increase fluid contact when in use, and may further include one or more drainage apertures 38 through which fluid may exit from the portable eyewash system 10 when in use. As a result of the conformity of the eyewash cups to the ocular contours of the face, a maximum amount of fluid is delivered directly to the affected eye regions while reducing the amount of fluid that is wasted, i.e., that is passed through the system without contacting the eye.

In an exemplary use of the portable eyewash system 10 of the present invention, the main conduit 12 is positioned proximate a dispensing fluid source. Examples of such fluid sources include common sink faucets, a portable water jug or container, a hose, or the like. Upon coupling the main conduit 12 of the portable eyewash system 10 to a fluid source, the flexible tubes extending from the fluid division conduit 20 of the portable eyewash system 10 are in a substantially upright position, thereby reducing the need to position or adjust the tubing to adequately expose the affected eye area to a fluid stream flowing through the tubing. As a result, the first and second eyewash cups are predisposed to a position that is easily accessible to the ocular region of an individual, virtually eliminating any need to adjust the angle or orientation of the portable eye wash system prior to use, and resulting in a reduction in the time needed to effectively administer aid.

Subsequently, fluid is dispensed from the fluid source and into the main conduit 12. The fluid flow then branches through the fluid division conduit 20 and into the first and second flexible tubes. The flow path of the fluid then leads into the first and second eyewash cups, where the eyes of the affected individual are rinsed. Fluid may exit the eyewash cups through the drainage apertures 38 in the first and second eyewash cups, or escape through spacing between the eyewash cups and the face of the person using the portable eyewash system 10.

When in use, should the fluid flow from the dispensing fluid exceed a desirable pressure, the fluid regulation element 32 may be adjusted in order to either decrease or increase the pressure, and thus the flow rate, of the fluid in the first and second flexible tubes which is subsequently delivered to the eyewash cups. Moreover, in the event fluid flow to the eyecups is unable to exit the portable eyewash system 10, thereby resulting in the accumulation of fluid and thus an increase in pressure within the portable eyewash system 10, the pressure relief valve 18 in the main conduit 12 may be triggered to provide an alternate path for the fluid to exit the system. The relief valve 18 may be such that it automatically opens in response to circumstances in which a predetermined pressure threshold is exceeded within the system.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A portable eyewash system for use with a fluid source, comprising:
a main conduit;
a first flexible tube in fluid communication with the main conduit;
a second flexible tube in fluid communication with the main conduit, a first eyewash cup coupled to the first flexible tube; and
a second eyewash cup coupled to the second flexible tube.

2. The portable eyewash system according to claim 1, wherein the first flexible tube is substantially perpendicular to a portion of the main conduit, and the second flexible tube is substantially perpendicular to a portion of the main conduit.

3. The portable eyewash system according to claim 1, wherein the main conduit defines an opening and an interior cavity.

4. The portable eyewash system according to claim 3, wherein the interior cavity forms a substantially obtuse angle.

5. The portable eyewash system according to claim 1, wherein the main conduit is engageable with the fluid source.

6. The portable eyewash system according to claim 1, wherein the main conduit includes a first portion which is substantially rigid, and a second portion which is substantially pliable.

7. The portable eyewash system according to claim 6, wherein the first portion is constructed from plastic.

8. The portable eyewash system according to claim 6, wherein the second portion is frictionally engageable with the fluid source.

9. The portable eyewash system according to claim 1, wherein the first and second eyewash cups are shaped to form a seal with a facial contour.

10. The portable eyewash system according to claim 9, wherein one of the first and second eyewash cups define a drainage aperture.

11. The portable eyewash system according to claim 1, further comprising a pressure relief element in fluid communication with the main conduit.

12. The portable eyewash system according to claim 1, further comprising a fluid regulation element coupled to one of the first and second flexible tubes.

13. The portable eyewash system according to claim 12, wherein the fluid regulation element is a pinch clamp.

14. The portable eyewash system according to claim 1, wherein the first flexible tube and the second flexible tube each maintain a substantially longitudinal configuration independent of additional support.

15. A portable eyewash system for use with a fluid source, comprising:
a main conduit defining an opening and an interior cavity, wherein the main conduit is engageable with the fluid source;
a fluid division conduit defining a fluid inlet, a first fluid outlet and a second fluid outlet, wherein the fluid division conduit is in fluid communication with the main conduit;
a first flexible tube coupled to the first fluid outlet;
a second flexible tube coupled to the second fluid outlet;
a first eyewash cup in fluid communication with the first flexible tube, wherein the first eyewash cup defines a first drainage aperture;
a second eyewash cup in fluid communication with the second flexible tube, wherein the second eyewash cup defines a second drainage aperture;
a first fluid regulation element coupled to the first flexible tube;
a second fluid regulation element coupled to the second flexible tube; and
a pressure relief element in fluid communication with the main conduit.

16. The portable eyewash system according to claim 15, wherein the first flexible tube and the second flexible tube each have a length substantially between approximately one inch and approximately ten inches.

17. The portable eyewash system according to claim 15, wherein the first flexible tube and the second flexible tube each maintain a substantially longitudinal configuration independent of additional support.

18. The portable eyewash system according to claim 15, wherein the first flexible tube and the second flexible tube are constructed from rubber.
